(19) United States
(12) Patent Application Publication
(10) Pub. No.: US 2003/0093695 A1
(43) Pub. Date: May 15, 2003

(54) Secure handling of stored-value data objects

(76) Inventor: Santanu Dutta, Cary, NC (US)

Correspondence Address: COATS & BENNETT, PLLC, P O BOX 5, RALEIGH, NC, 27602, US

(21) Appl. No.: 10/103,502

(22) Filed: Mar. 21, 2002

Related U.S. Application Data
(63) Continuation-in-part of application No. 10/008,174, filed on Nov. 13, 2001.

(51) Int. Cl. H04L 9/00

(52) U.S. Cl. 713/201; 713/150

(57) ABSTRACT

An approach to managing stored-value data objects, such as electronic tickets, comprises secure systems and procedures for ticket issuing, storage, and redemption. With these systems and procedures in place, stored-value data objects may be securely transferred to remote systems, such as a user's personal electronic device, for subsequent secure redemption, thus allowing the user to gain access to the desired goods or service upon redeeming the data object. Techniques provide secure delivery of the requested data object to the requesting device, and provide secure redemption and disposal of the data object. Ticket issuing systems may be Internet-accessible systems, and users may purchase and redeem tickets using mobile terminals or other devices adapted for wireless communication. Standardized WPKI and Internet access procedures may be employed in ticket issuance and redemption. Techniques further provide temporary and rapid verification data objects useful where rapid ticket verification is essential, such as mass transit systems.

### RELATED APPLICATIONS

This application is a continuation-in-part (CIP) of the co-pending and commonly assigned U.S. patent application Ser. No. 10/008,174, filed on Nov. 13, 2001, and entitled “Secure Handling of Stored-Value Data Objects,” and which is incorporated by reference herein in its entirety, and from which priority is claimed under 35 U.S.C. § 120.

### BACKGROUND OF THE INVENTION

The present invention generally relates to conducting secure transactions, and particularly relates to securely managing wireless device transactions involving stored-value data objects.

As portable electronic devices become more fully integrated into the everyday lives of people, these devices will be used in a broader range of transactions. For example, one might integrate payment functions into a portable communication device such as a cellular telephone. A user can then pay for selected goods or services using the phone's payment functions.

Security issues complicate using portable devices in commercial transactions. For example, if the user's device contains payment information, how is that information conveyed to a vendor system in a manner secure from unwanted eavesdropping or monitoring? In general, significant issues arise in providing end-to-end security for such transactions.

Particular challenges arise in securely delivering and retrieving information to and from a portable device. The need for such delivery and subsequent retrieval might arise in the context of delivering a stored-value data object to the device for later redemption by the user. Here, the data object might function analogous to a physical ticket. Indeed, a vendor might issue an electronic ticket or other token for delivery to the user's device for subsequent redemption. Upon redemption of the electronic ticket, the user gains access to or receives the desired goods or service.

However, the use of electronic tickets or other stored-value data objects requires significant security provisions throughout the issuing and redeeming processes. An approach to securely managing the use of stored-value data objects with portable devices requires a solution that addresses these and other security concerns. Yet, any such approach should make the use of such data objects relatively convenient and flexible from the user's perspective.

### BRIEF SUMMARY OF THE INVENTION

The present invention provides methods and apparatus for securely managing wireless device transactions involving the use of stored-value data objects. In some embodiments, the stored-value data object functions as an electronic ticket or token, and methods and apparatus are provided for securely issuing, storing, and redeeming the electronic ticket.

In at least one embodiment, the wireless device requests a desired stored-value data object from a ticket issuing system. The ticket issuing system ensures secure delivery to the requesting device by encrypting the requested data object using a public key provided by the wireless device in association with the request. Only the requesting wireless device has the corresponding private key, and thus only that device can decrypt and subsequently use the data object. The wireless device may include a security element, which offers tamper-resistant, secure decrypting and storage for the data object, and secure storage of the private key.

The ticket issuing system may offer local access, in which case the wireless device might use RF or optical (e.g., infrared) signaling to communicate with the ticket issuing system. In at least one embodiment, the ticket issuing system is a remote server or other system accessible through the Internet, and the wireless device accesses it through a wireless communication network. For example, the device might incorporate a RF transceiver adapted to communicate with a cellular communication network. Communication between the internet-based ticket issuing system and the wireless device might use the Wireless Application Protocol (WAP). If WAP is used, the wireless device might provide its associated public key to the ticket issuing system in a user certificate, in accordance with WAP Public Key Infrastructure (WPKI) methods.

After receiving the stored-value data object (e.g., electronic ticket) in encrypted form from the ticket issuing system, the wireless device transfers the encrypted data object to its security element, which may be integrated in the wireless device or removeably connected therewith. In any case, the security element provides for secure storage of the data object and does not permit viewing, retrieving, or otherwise modifying the stored data object except in accordance with its security rules. As noted, the security element also may provide secure storage of the private key used to decrypt the data object as received from the ticket issuing system. Additionally, the security element may allow a user of the wireless device to browse or view selected fields or portions of the stored data object, but prevents unauthorized retention of a redeemable copy of the stored data object by not allowing unencrypted access to the full data object.

Once the security element contains a stored data object, such as an electronic ticket, the wireless device user can redeem the data object for associated goods or services at a compatible ticket redeeming system. The ticket redeeming system ensures that the data object being redeemed is valid, and cooperates with the security element in the redeeming wireless device to ensure that unauthorized copies of the stored data object cannot be extracted by eavesdropping on the communication between the wireless device and the ticket redeeming system. Further, the security element in the wireless device ensures that unauthorized copies of the stored-value data object are deleted or otherwise not retained. Communication between the wireless device and the ticket redeeming system may use RF, infrared, or other wireless signaling. In at least one embodiment, the wireless device includes an RF interface, such as a Bluetooth interface, for communicating with the ticket redeeming system. Communication between the ticket redeeming system and the wireless device may be based on WAP, or on other standardized or proprietary protocols.

In at least some embodiments, the wireless device initiates redemption of the stored data object by sending a redemption request to the ticket redeeming system. The wireless device may also provide its associated public key to the ticket redeeming system as part of this request. In response, the ticket redeeming system sends a certificate containing its associated public key to the wireless device. The ticket redeeming system may also send a nonce (“number used once”) or other generated value (e.g. pseudorandom value) to the wireless device.

The security element encrypts a combination of the generated value supplied by the redeeming system and the ticket using the public key received from the redeeming system. The wireless device then sends the encrypted data object to the ticket redeeming system using whatever protocols are associated with the particular interface used to communicate with the ticket redeeming system. Generally, these protocols should support transmission verification to insure that the ticket redeeming system successfully receives the encrypted data object. Upon transmitting the data object to the ticket redeeming system, the security element in the wireless device erases or otherwise clears its stored copy of the data object.

In some embodiments, the security element processes stored-value data objects such that only an index value and a freshness flag (used/not used) is retained in secure memory by the security element. In such embodiments, the security element generates a binding value that links the index value to the stored-value data object and allows it to be written out to non-secure memory rather than be held within the security element. Notably, this approach permits a portion of the stored-value data object to be stored in the non-secure memory as clear text, which greatly facilitates ticket browsing or other inspection activities.

Regardless of the particular approach taken by the security element with regard to storage of the stored-value data object, the ticket redeeming system decrypts the received data object using a private key corresponding to the public key it provided to the wireless device. During decryption, the ticket redeeming system separates the data object from the nonce and verifies that the data object contains an authentic signature or other marking data from a legitimate ticket issuing system, or from a legitimate ticket redeeming system. If the data object is a multi-use object, such as a multi-use electronic ticket, the ticket redeeming system alters the data object as required, signs it with its own private key, and,then returns it in encrypted form to the wireless device, where it is decrypted and stored in the security element, ready for subsequent redemption.

In any case, the ticket redeeming system may offer or otherwise enable access to the goods or service associated with redeeming the data object, such as by opening a gate or by returning a rapid verification token (RVT), in exchange of the data object, to the wireless device for subsequent use in accessing the goods or service. A RVT as defined herein typically comprises a different type of information than the data object discussed above, and has associated transfer and verification procedures making it amenable to quick verification.

A RVT, or, more generally, a rapid verification object (RVO), might be used in situations where one or more subsequent rapid verifications are desired after initial redemption of a stored data object using full security. For example, a ticketed passenger might use his or her portable device to perform full redemption of a stored electronic ticket at a ticket redeeming system positioned in advance of the boarding area. Upon redeeming the electronic ticket, the ticket redeeming system returns a RVT to the passenger's portable device, which may then be rapidly verified immediately prior to boarding the aircraft. Of course, usage of RVTs extends to a broad range of other activities such as enforcing ticketed access at sporting events.

In at least some embodiments, the ticket redeeming system returns a seed value to the wireless device, and may optionally return graphical data or pattern generating information. The seed value may be a pseudorandom value. The security element in the wireless device uses the returned seed value to drive some form of pattern or sequence generator. The pattern/sequence generator preferably incorporates time-ofday dependency in its generation function, such that the sequence or pattern generated by it depends on both the seed value and the time-of-day. If a human operator is meant to redeem or authenticate the RVT, the security element can generate an authentication pattern or otherwise manipulate a graphical element that it displays in a manner dependent upon the seed value, and on time-of-day if desired. Thus, only security elements having valid seed values are able to present the proper pattern or graphical manipulation to the verifying human operator at the verification instant.

Incorporating time-of-day considerations into sequence/pattern generation functions protects RVT verification against replay attacks. In general, the pattern/sequence generator generates the desired pattern or sequence at the time of verification. In so doing, the time-of-day used in generation is very close to current time. For example, the pattern/sequence might be generated a half-second before actual verification. Verification might then be made to depend on the time-of-generation being within a certain window of time. This dependency prevents a user from outputting an otherwise valid verification pattern or sequence for recording and subsequent playback to a verifying system.

Where a subsequent automated system is meant to verify the RVT, the wireless device may simply transmit a verification sequence to the verifying system. Generally, the verification sequence contains at least one pseudorandom element generated in dependence on the seed value, and preferably also in dependence on the time-of-day. The verifying system receives the verification sequence and checks its validity. It does so by locally generating the same pseudorandom element or elements in the verification sequence, which is feasible because the verification system has knowledge of the seed value that was transmitted to the wireless device by the ticket redeeming system (TRS). This seed value is used system-wide, that is, it is given to all wireless devices over a moderately long pre-determined period of time. The period of time may be much longer than the typical user delay between redeeming the ticket at the first TRS and subsequently redeeming the RVT. The RVT-checking TRS would allow acceptance of both the present and the previous period seeds over a relatively brief period following a seed-change; this would accommodate users who obtained their seed just prior to a seed change.

If the pseudorandom element is generated in dependence of time-of-day as well as the seed value, the wireless device may transmit the time-of-day it used in generating the pseudorandom element included in its verification sequence. The verifying system can use this received-time-of-day value and the known seed value to generate its own pseudorandom element for comparison against the pseudorandom element received from the wireless device. Further, the verifying system may qualify the time-of-day received from the wireless device to make sure it is not old (i.e., stale).

Alternatively, verifying system may be synchronized to the same time reference as the wireless device, such that the time-of-day maintained by the verifying system closely matches the time-of-day maintained by the wireless device. If such synchronization is not desirable, the verifying system may allow for a defined time variance between it and the wireless device. In any case, the verifying system may also use the time-of-day in determining whether a received verification sequence is valid, thus preventing a given verification sequence from being copied and reused by other wireless devices.

Beyond specific considerations relating to (RVO) usage, the overall approach to secure handling of stored-value data objects may be enhanced by the adoption of symmetrical protocols for issuance and redemption operations. For example, the security element in the wireless device might generate a request nonce that is sent in conjunction with a request for a stored-value data object. The issuing system in turn includes the request nonce in the returned stored-value data object, which allows the requesting wireless device to verify the “freshness” of the received stored-value data object and thereby thwart malicious copying of an otherwise valid stored-value data object. Similarly, the redeeming system might send a redemption nonce to the wireless device during redemption operations. In turn, the security element of the wireless device can include the redemption nonce in the stored-value data object transferred by it to the redeeming system. Thus, nonces are generated by the system requesting transfer of the stored-value data object, whether during issuance or redemption.

Of course, the present invention includes features and advantages beyond those identified in this brief summary. Such additional features and advantages will be recognized by those skilled in the art upon reading the following detailed description, and in light of the supporting drawings, in which like elements are generally referred to with common reference numbers.

### BRIEF DESCRIPTION OF THE DRAWINGS

FIG. 1 is a diagram of an exemplary system supporting the secure handling of stored-value data objects in accordance with the present invention.

FIG. 2 is a more detailed diagram of an exemplary embodiment of the system of FIG. 1.

FIG. 3 is a diagram of exemplary embodiments of the ticket issuing system, ticket redeeming system, and personal trusted device shown in FIGS. 1 and 2.

FIG. 4 is an exemplary call flow diagram detailing the issuance and redemption of electronic tickets or other types of stored-value data objects.

FIG. 5 is a diagram of an exemplary environment suited for the use of rapid verification tokens.

FIG. 6 is a diagram of an exemplary verification display associated with a rapid verification token.

FIGS. 7A-7E.are an exemplary flow diagram illustrating an alternate embodiment of the present invention in which stored-value data objects may be stored in non-secured memory.

FIG. 8 is a diagram illustrating changes to the illustration of FIG. 2 in support of the functionality detailed by FIGS. 7A-7E.

FIG. 9 is a consolidated flow diagram providing an overview of issuance and redemption operations in the context of FIGS. 7A-7E.

### DETAILED DESCRIPTION OF THE INVENTION

The present invention provides systems and methods enabling certain transactions related to wireless e-commerce. The following detailed description and accompanying drawings provides specific, exemplary details regarding implementations for at least some embodiments of the present invention. However, the scope of the present invention extends well beyond these specific details. For example, it should be understood that where wireless communication systems are involved, no particular wireless communication interface standard is necessary for practicing the present invention.

Moreover, the discussion below refers specifically to electronic tickets, but this term should be understood to be a particular embodiment of the more general concept of any stored-value data object. Thus, the term “electronic ticket” as used herein encompasses other stored-value data objects, such as electronic cash, electronic tokens, and any other data item or object that may be used as a medium of exchange in e-commerce, and in other for-value transactional activities.

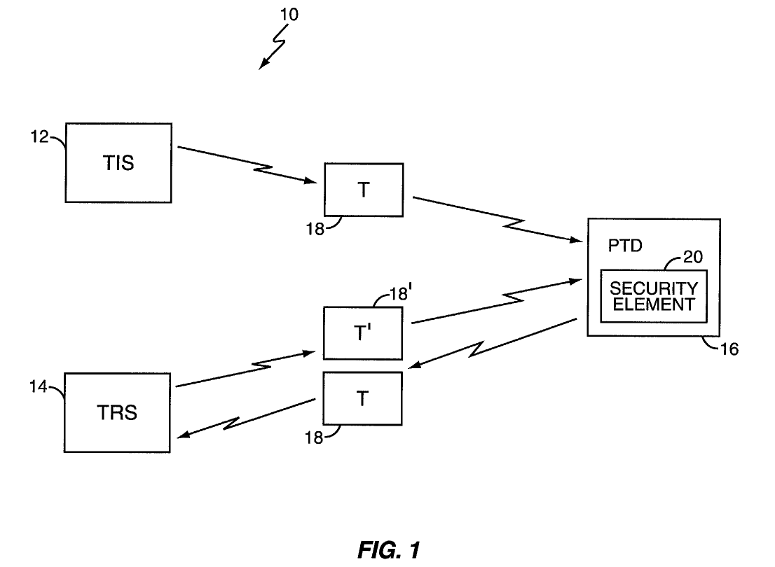

FIG. 1 illustrates a simplified, exemplary system 10 for practicing one or more embodiments of the present invention. System 10 comprises a ticket issuing system (TIS) 12, a ticket redeeming system (TRS) 14, and a user device 16. In this context, the user device 16 is referred to herein as a “personal trusted device” (PTD) 16. The PTD 16 contains a security element 20, which is adapted to act as a trusted agent of the TIS 12 and TRS 14 in stored-value data object transactions, such that the security element 20 cooperates with the TIS 12 and TRS 14 in securely issuing, storing, and redeeming an electronic ticket 18. It should be understood that the PTD 16 represents essentially any device type having the appropriate wireless communication capabilities. Thus, PTD 16 might be an appropriately configured radiotelephone or other mobile terminal, personal digital assistant, hand-held, laptop, other personal computer device, or other type of electronic device.

In managing the secure transfer, handling, and redemption of electronic tickets, the systems and processes used must ensure reliable and convenient electronic ticket generation, issuance, and redemption, which includes preventing fraud and misuse. In general, the TIS 12, TRS 14, and security element 20 cooperate to achieve the following goals:

The ticket recipient must be assured that the ticket issuer is legitimate.

The ticket must be delivered only to the legitimate user, i.e., it shall not be possible for a person other than the user to receive and make use of the ticket.

The ticket must be prevented from copying by the user, whether such copying might be undertaken legitimately or fraudulently.

The user must be assured that the ticket collector (redeeming system) is legitimate.

The ticket must be delivered only to the legitimate ticket collector, i.e., it shall not be possible for an entity other than the legitimate ticket collector to receive and make use of the ticket.

The ticket collector must have a reliable mechanism for ensuring that the ticket is legitimate.

If the ticket collector returns the ticket to the user, it must ensure that the ticket is delivered only to the legitimate user, i.e., it shall not be possible for a person other than the user to receive and make use of the returned ticket.

In addition to the above secure handling requirements, rapid ticket verification is also a requirement in many ticketing services. Rapid verification is especially advantageous in mass transit systems, sports events, concerts, etc. With rapid verification, which is discussed in more detail later, there may be a tradeoff between verification security and verification speed. In general, the concept entails subjecting an electronic ticket to a high level of initial security involving a potentially complex and time-consuming verification process, and subsequently providing the user with a potentially less secure, short-lived, rapid verification object that may be verified more quickly than the original electronic ticket.

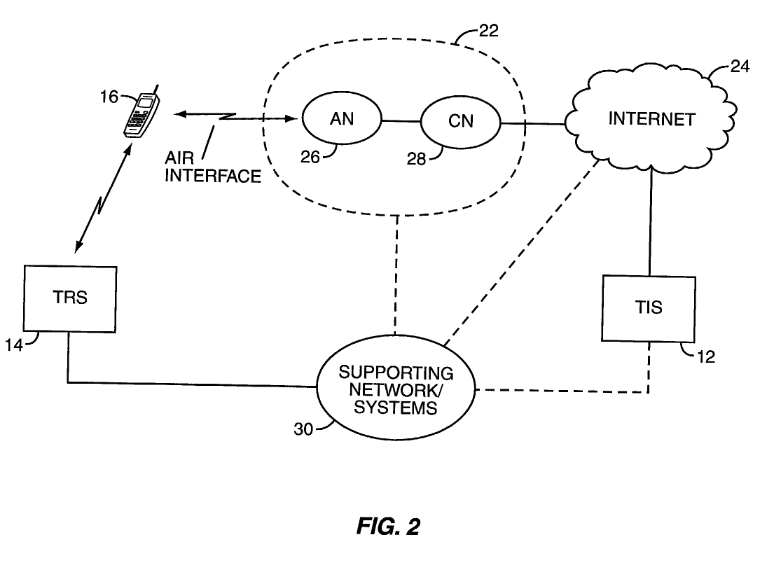

FIG. 2 is a more detailed illustration of an exemplary embodiment of secure ticket transactions. In this instance, the PTD 16 may be a mobile terminal or other cellular radiotelephone. As such, the PTD 16 wirelessly communicates with the TIS 12 by accessing the wireless communication network 22, which typically comprises an access network (AN) 26 and a core network (CN) 28. The wireless communication network 22 provides access to the TIS 12 via the internet 24 or by some other network connection. The wireless communication network 22 may be any one of a number of standardized network implementations, including GSM, CDMA (IS-95, IS-2000), TDMA (TIA/EIA-136), wide band CDMA (W-CDMA), GPRS, or other type of wireless communication network.

Any number of end-to-end protocols may be used in supporting ticketing transactions conducted between the PTD 16 and the TIS 12. For example, the TIS 12 may be a WAP-enabled server, thereby allowing WAP-enabled PTDs 16 to conduct ticketing transactions with the TIS 12 based on WAP standards in conjunction with special MIME types defined for the ticketing messages. In particular, the reader is referred to the standards document entitled “Wireless Application Protocol Public Key Infrastructure Definition,” WAP-271-WPKI, Version Apr. 24, 2001, as promulgated by the WAP Forum. Of course, other protocols may be used, and indeed numerous open and proprietary protocols are available for supporting transactions between the PTD 16 and the TIS 12.

Moreover, it should be understood that while configuring the TIS 12 as an Internet-accessible ticket issuing system is attractive in terms of flexibility and broad access, the TIS 12 might be implemented as part of the wireless communication network 22. For example, the TIS 12 may be implemented as one of a number of network entities within the core network 28. In that case, some security concerns associated with the TIS 12 are eliminated, or at least minimized, but access to the TIS 12 may be more restricted. For example, the TIS 12 might be accessible only to subscribers of the wireless communication network 22.

Once the PTD 16 receives an electronic ticket from the TIS 12, it transfers the ticket 18 to its security element 20, where it is decrypted and securely held for subsequent redemption. To that end, the PTD 16 further supports wireless communication with the TRS 14 for redemption transactions. The TRS 14 may be linked to other systems via a supporting network 30, and in fact may be connected to one or more of the Internet 24, the TIS 12, and the wireless communication network 22. While not shown, it should be understood that the TRS14 may also be linked directly or indirectly to other TRSs 14, and to other types of equipment associated with ticket redemption, and, optionally, may be linked with rapid verification systems discussed later herein.

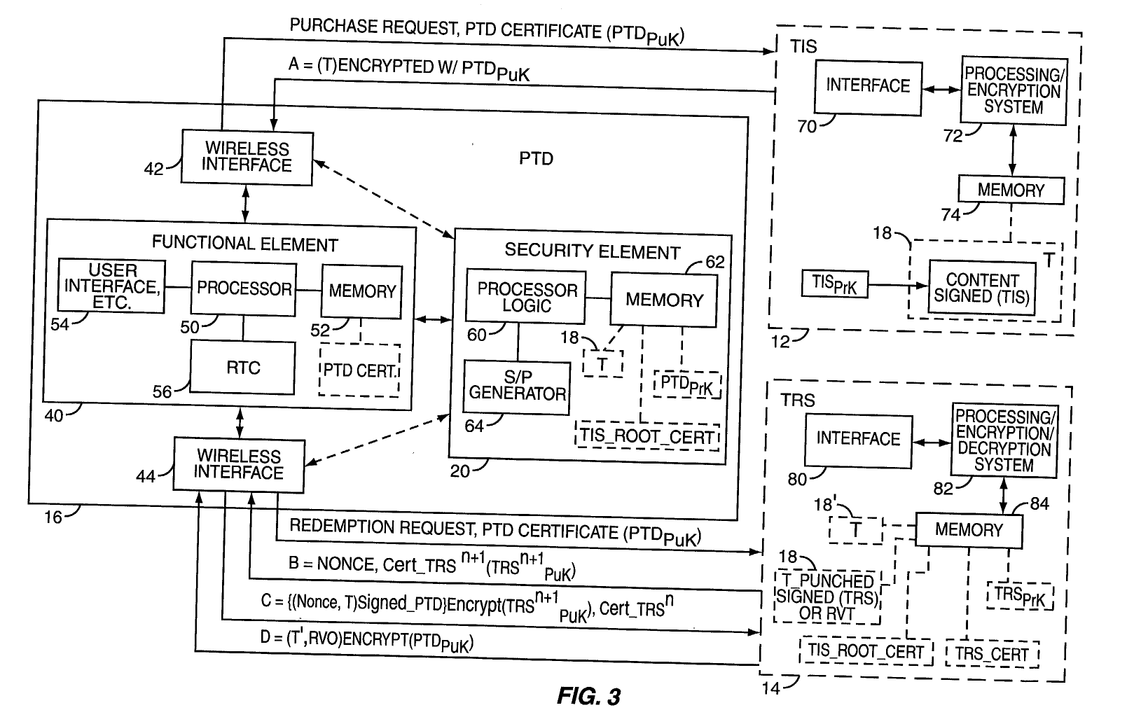

FIG. 3 provides more detail regarding exemplary embodiments of the TIS 12, the TRS 14, and the PTD 16. Additionally, FIG. 3 defines exemplary information exchanged between the PTD 16 and the TIS 12 and TRS 14.

Specific embodiments of the PTD 16 will vary significantly because the term “PTD”, as used herein, encompasses a broad range of device types. In an exemplary embodiment, the PTD 16 comprises a functional element 40 and wireless interfaces 40 and 42, in addition to the security element. As used herein, the term “functional element” essentially describes the whole of the PTD 16 apart from the security element 20 and the wireless interfaces 42 and 44. As will be explained later, the PTD 16 may use the same wireless interface 42 or 44 to communicate with both the TIS 12 and the TRS 14, but will oftentimes incorporate separate wireless interfaces. Generally, the need for different wireless interfaces is determined based on whether the TIS 12 and the TRS 14 are both local systems, both remote systems, or a mix of remote and local systems. For example, as described earlier, the PTD 16 may communicate with the TIS 12 using WAP services supported by the wireless communication network 22, while communicating with the TRS 14 at a redemption site via a local communication link.

The characteristics of functional element 40 will vary depending upon the nature of the PTD 16. That is, functional element 40 may include the baseband processing unit and user interface of a cellular telephone, a personal digital assistant (PDA), or other type of electronic device dependent on the intended purpose of the PTD 16 in question. Generally, the functional element 40 comprises some type of processor or processors 50, memory 52, a user interface 54 and a real-time clock (RTC) 56. Details of the user interface 54 also vary with the intended purpose of the PTD 16. For example, if the PTD 16 is a cellular telephone or other mobile terminal, the user interface 54 typically comprise a display screen, keypad, and audio input/out systems. Similarly, if the PTD 16 is a PDA or other mobile computing device, the user interface 54 generally includes display and input/output functions.

The security element 20 in the PTD 16 may be implemented in any number of ways. For example, the security element 20 may be integrated with the other systems of the PTD 16, or may be a removable smart card or other modular device. In any case, the security element 20 may be implemented as a tamper-resistant secure module that provides for highly secure storage of electronic tickets and other sensitive data. In an exemplary embodiment, the security element 20 comprises a processor, or other logic 60, memory 62, and a sequence/pattern generator 64. Functions associated with the security element 20 are described in more detail later in association with describing transactions involving the TIS 12 and TRS 14.

In an exemplary embodiment, the TIS 12 comprises a WAP-enabled server, or other network-accessible ticket issuing system. In general, the TIS 12 includes an interface 70 configured for the type of network with which the TIS 12 communicates. In some embodiments, the interface 70 may include wireless communication functionality to support local wireless communication with PTDs 16. The TIS 12 further comprises a processing/encryption system 72 and memory 74.

Similarly, the TRS 14 comprises an interface 80, a processing system 82 providing encryption and decryption services, and memory 84. Of course, both the TIS 12 and the TRS 14 may be implemented differently depending on the specific capabilities and communication methods desired.

Independent of the above implementation details, a typical electronic ticket transaction involves a purchase request from the PTD 16 to the TIS 12, and subsequent delivery of the requested electronic ticket 18 from the TIS 12 to the PTD 16. Later, a user of the PTD 16 presents the electronic ticket 18 to the TRS 14 for redemption. A number of mechanisms are used within the present invention to ensure end-to-end security for issuing, storing, and redeeming electronic tickets (i.e., stored-value data objects).

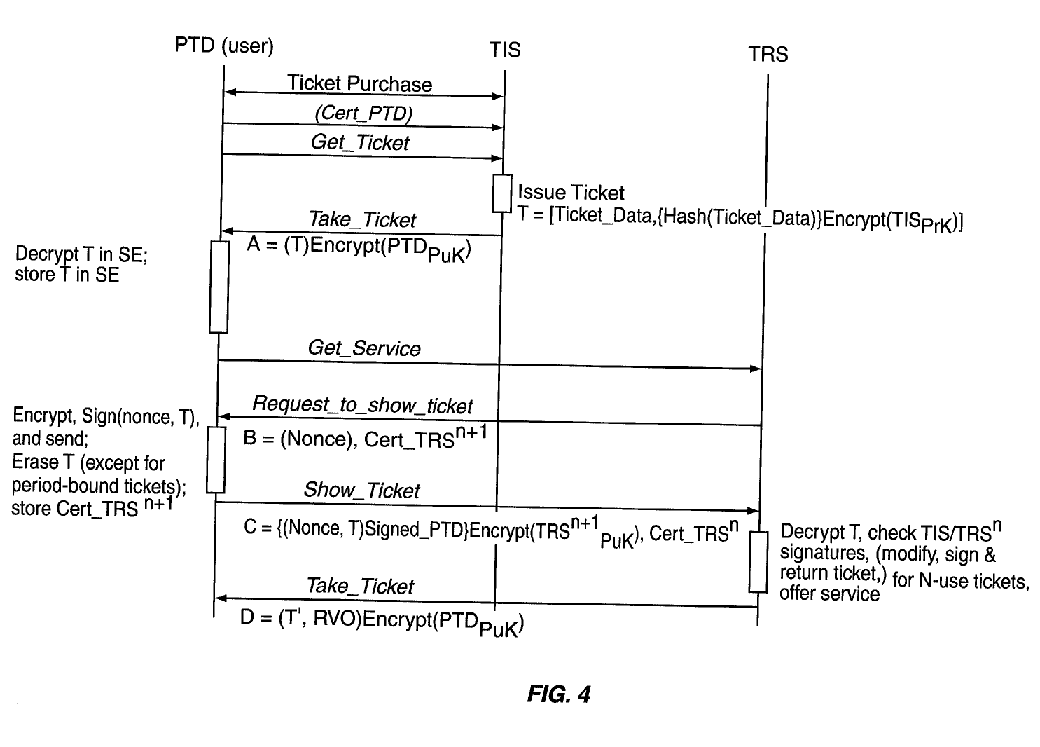

FIG. 4 illustrates an exemplary call flow that might be practiced in one or more embodiments of the present invention. The overall set of electronic ticket transactions begins with the PTD 16 generating and transmitting a purchase request for receipt by the TIS 12. A user certificate that includes a public key associated with the PTD 16 is transmitted in conjunction with the purchase request, or is otherwise made available to the TIS 12. The PTD certificate may be a certificate issued by the operator of the TIS 12 or an associated system, or may come from a trusted third party such as VISA or MASTERCARD. In any case, once the TIS 12 is assured of payment for the electronic ticket 18, which procedures are not germane to the present invention, it generates the requested electronic ticket 18.

Referring back to FIG. 3 it might be noted that the ticket 18 may be generated and held in memory 74. Once the ticket 18 is generated with the desired content and signed or otherwise authenticated by the TIS 12, it is encrypted using the public key (PTD_{PuK}) associated with the requesting PTD 16. Because only the requesting PTD 16 has the corresponding private key, only the requesting PTD 16 will be able to receive and make use of the encrypted ticket 18. Thus, in FIG. 4, corresponding to Message A, the TIS 12 issues the requested electronic ticket 18 in encrypted format. Note that the ticket 18 consists of data that is digitally signed by the TIS 12, the digital signature being performed by encrypting the ticket data (TICKET_DATA) with a private key (TIS_{PrK}) belonging to and securely held by the TIS 12.

The PTD 16 receives the encrypted ticket 18 via the wireless interface 42, and may pass the encrypted ticket 18 directly to the security element 20, or indirectly through the functional element 40. In one embodiment, the TIS 12 sends the encrypted electronic ticket to the PTD 16 as a special Multipurpose Internet Mail Extension (MIME) type, which message type triggers the transfer of the encrypted ticket 18 to the security element 20. In any case, the security element 20 decrypts the received ticket 18 using its securely held private key. The security element 20 may hold a root certificate (TIS_ROOT_CERT) corresponding to the TIS 12, which certificate includes the private key needed to decrypt the electronic ticket 18 received from the TIS 12.

The decrypted ticket 18 is held in security element memory 62. It is noteworthy that the security element's fixed, pre-defined input/output functions never yield the decrypted electronic ticket 18 to the outside world. Hence, the ticket 18 stored in the security element 20 is inaccessible to would-be copiers, although the security element 20 may make selected fields or portions of the ticket 18 available for browsing by the user of PTD 16.

Subsequent to receiving the ticket 18 from the TIS 12, the user of the PTD 16 presents the electronic ticket 18 to the TRS 14 for redemption. Ticket redemption typically begins with the PTD 16 issuing a redemption request to the TRS 14, which might take the form of a WAP Session Protocol (WSP) Get request from the PTD 16 to the TIS 12, as shown in FIG. 4 by the Get_Service message. The above Get message may be issued as a result of the user independently navigating to a TIS website, or by the receipt by the PTD 16 of a WAP Push message issued by the TIS 12, containing the url of the TIS 12, and the user selecting the said url on his PTD.

As was mentioned early, the PTD 16 preferably communicates with the TRS 14 wirelessly through wireless interface 42 or 44. If the TRS 14 is remote, the PTD may access it as it would a remote TIS 12 through the wireless communication network 22, in which case the PTD 16 uses wireless interface 42. If the TRS 14 is local, the PTD 16 uses wireless interface 44, which may comprise a radio fre interface, some combination thereof, or may be based on some other wireless technology. Wireless technologies of particular interest in this context include Bluetooth and 802.11 wireless networking standards, and additionally include the infrared communications standards promulgated by the Infrared Data Association (IrDA). Of course, it should be understood that communication between the PTD 16 and the TRS 14 might be based on other standards, including proprietary communication protocols.

Upon receiving the redemption request from the PTD 16, the TRS 14 sends a message, B, termed “Request To Show Ticket” to the PTD 16, which request includes a generated value and a certificate (Cert_TRSⁿ⁺¹) associated with the particular TRS 14. The generated value may be a nonce, for example. The certificate transferred from the TRS 14 to the PTD 16 includes a public encryption key (TRS_{PuK}) associated with the TRS 14.

In response, the security element 20 within the PTD 16 creates a composite data object, (Nonce, T), comprising the received generated value concatenated with the electronic ticket 18. This composite data object is then digitally signed by the PTD 16 using the private key of the PTD 16. Preferably, a standard format such as PKCS 7, is used, whereby the certificate containing the PTD's public key, Cert_PTD, is appended to the signed object. The signed composite data object is then encrypted with the public key belonging to the particular TRS 14, the said public key being contained in the certificate, Cert_TRSⁿ⁺¹, sent from the TRS 14 to the PTD 16 in message B in the previous step. In this discussion, the present TRS 14 is identified by index number (n+1) and a previous TRS, for multi-use tickets, by (n).

Following encryption of the signed composite data object, the PTD 16 returns the encrypted composite object to the TRS 14. For multi-use tickets described below, the certificate of the previous ticket redeeming system, Cert_TRSⁿ, is also sent as a component of message C. The TRS 14 decrypts the received generated value and electronic ticket 18 using the corresponding private key (TRS_{PrK}), known only to that TRS 14, and checks the authenticity and integrity of the received electronic ticket, as well as verifies the returned generated value.

In particular, the TRS 14 checks whether the received electronic ticket includes an authentic signature or other verification information from a legitimate TIS 12 and/or from another TRS 14, which might have signed a multi-use ticket after modifying it, as described below. In so checking, the TRS 14 may use a locally stored copy of the root certificates of one or more TISs 12 and the certificate of the previous TRS received from the PTD 16.

The TRS 14 may also check the PTD's signature on the composite data object returned by the PTD 16 to verify possession by the PTD 16 of the private key corresponding to the public key contained in the submitted PTD certificate.

If the electronic ticket 18 being redeemed at the TRS 14 is a one-time use ticket, the TRS 14 verifies that the ticket is valid and provides a signal or other indication to an associated system that the presenter of the ticket 18 should be granted access to the goods or service corresponding to the received ticket 18, or that a RVT should be issued. In conjunction with transmitting the ticket 18 from the PTD 16 to the TRS 14 in association with its redemption, the security element 20 erases the secure copy of the ticket 18 that it holds within its memory 62. This prevents unauthorized duplicate copies of the ticket 18 remaining during or after redemption.

In some instances, the electronic ticket 18 is a multiple use ticket. If so, the TRS 14 may return a redeemed ticket 18′. The redeemed ticket 18′ may comprise a “punched”, that is, an altered copy of the original electronic ticket 18. For example, the TRS 14 may modify the original electronic ticket 18 to show that it has been redeemed for the nth time, where n is a number from one (1) to the maximum number of times that the ticket 18 may be used. In returning a multi-use ticket 18′, the TRS 14 may modify the ticket contents to contain an authentication signature associated with the TRS 14, which may be used to verify the redeemed ticket 18′ at subsequent verification points.

In some cases, the result of redeeming a ticket 18 will be the issuance of a rapid verification object by the TRS 14. The PTD 16 receives the rapid verification object, and later uses it to generate a RVT, which may be quickly validated, albeit with less security, at a subsequent verification point. The rapid verification object sent from the TRS 14 to the PTD 16 itself might comprise the RVT, which is presented by the PTD 16 at a later verification point, but typically, the rapid verification object is a seed value, possibly with other information, from which the PTD 16 generates a valid RVT. Other information sent by the TRS 14 as part of the rapid verification object may include image data, image manipulation information, user-identifying data, etc. In any case, the TRS 14 might, depending on circumstances, return a redeemed ticket 18′, a rapid verification object, neither, or both.

The use of RVTs might arise in association with tickets 18 issued for sporting events or for use at train stations, for example. In this instance, an original electronic ticket 18 might be subject to verification at a TRS 14 positioned at an open access area, whereupon the TRS 14 returns a rapid verification object to the redeeming PTD 16, which object, used in generating the RVT, may remain valid only for a defined period of time or a defined number of subsequent RVT validations.

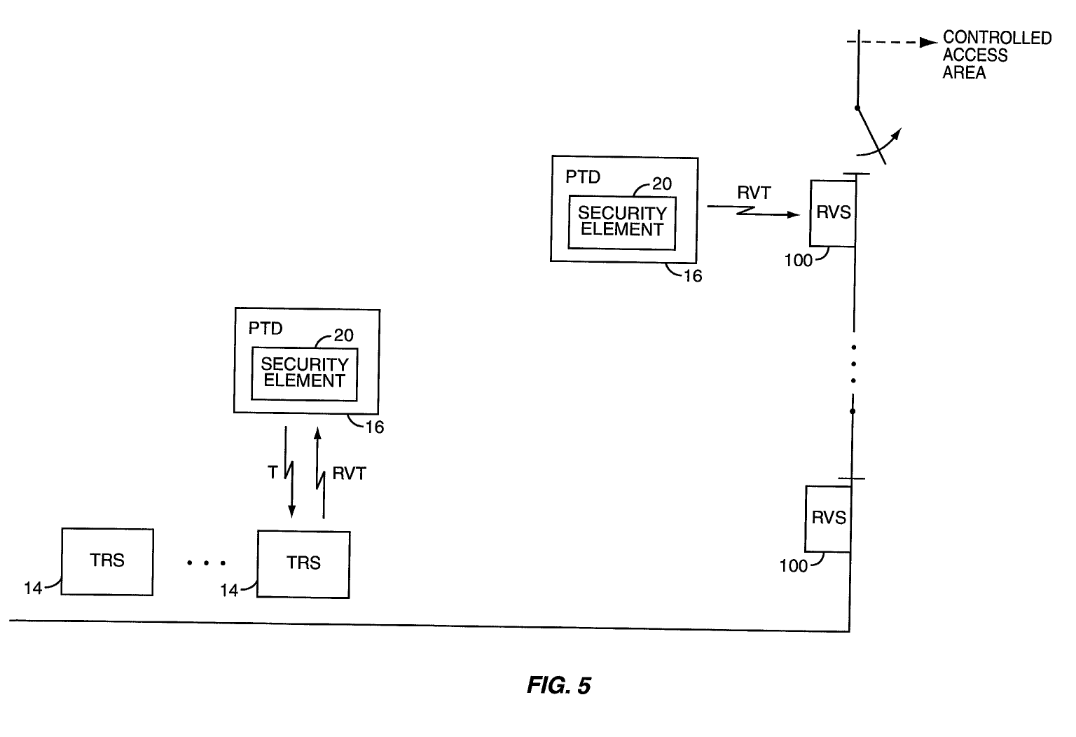

FIG. 5 illustrates more specifically an environment where RVTs might be useful. One or more TRSs 14 are available in an open area where users of PTDs 16 may initially redeem their electronic tickets 18. This initial redemption is typically a high security process, for example, one performed in accordance with the above description. The TRSs 14 return rapid verification objects to PTDs 16 redeeming valid electronic tickets 18. The PTD users may then present RVTs from their PTDs 16 to gain access to a controlled access area, for example. Arrangements of this sort are particularly useful in circumstances where event attendees or service users arrive at staggered times in advance of the event or service, and then subsequently queue up at a particular time. One might imagine the usefulness of the combination of high security verification followed by a subsequent lower security but faster verification at airport terminals, and at other mass transit facilities.

RVTs may be verified by rapid verification systems 100, but might also be verified by human operators. It should be understood that rapid verification systems 100 might simply be implemented as TRSs 14 but adopting both the secure verification protocols discussed earlier as well as lower-overhead rapid verification protocols. When returning rapid verification information to PTDs 16 from TRSs 14, the TRSs 14 may include a variety of data elements. In exemplary embodiments, the TRS 14 returns at least a seed value, and may also return visual pattern generating information, image information, and one or more associated scripts, the use of which information is explained below.

In one approach, the TRS 14 returns an image and a seed value in encrypted format as the rapid verification object to the PTD 16. The security element 20 in the PTD 16 includes a sequence/pattern generator 64 capable of generating pseudorandom sequences, or visual pattern information for display on the PTD screen, using the returned seed value. Additionally, the sequence/paftern generator 64 may be adapted to generate pseudorandom sequences based not only on this returned seed value, but on the time of day value that might be obtained from the real-time clock 56, for example. In many instances, the RTC 56 is itself synchronized to an overall network time or other referenced time, such as a GPS-based reference time. By making the RVT presented by the PTD 16 for verification dependent on time-of-day, the ability to fraudulently replay an earlier-generated RVT is eliminated.

In an exemplary scenario, a time-varying image is generated by the security element 20 in the PTD 16 by one of two approaches. A bit-mapped core image, which may be in data-compressed form, is transmitted from the TRS 14 to the PTD 16; this image is then manipulated by a program (e.g., computer instructions) native to the security element 20. This security element program takes as its inputs the output from the sequence/pattern generator 64, and the time time-of-day output or derived from the RTC 56. Alternatively, the program for creating and manipulating the time-varying image is itself sent from the TRS 14 to the PTD 16, possibly in compressed data form. This latter alternative is more suitable when the displayed image is an abstract, computer-generated pattern. It is noteworthy that the verification image displayed by the PTD 16, regardless of how it is generated, should have the qualities of easy human recognition, including clear discrimination among its various manipulated forms.

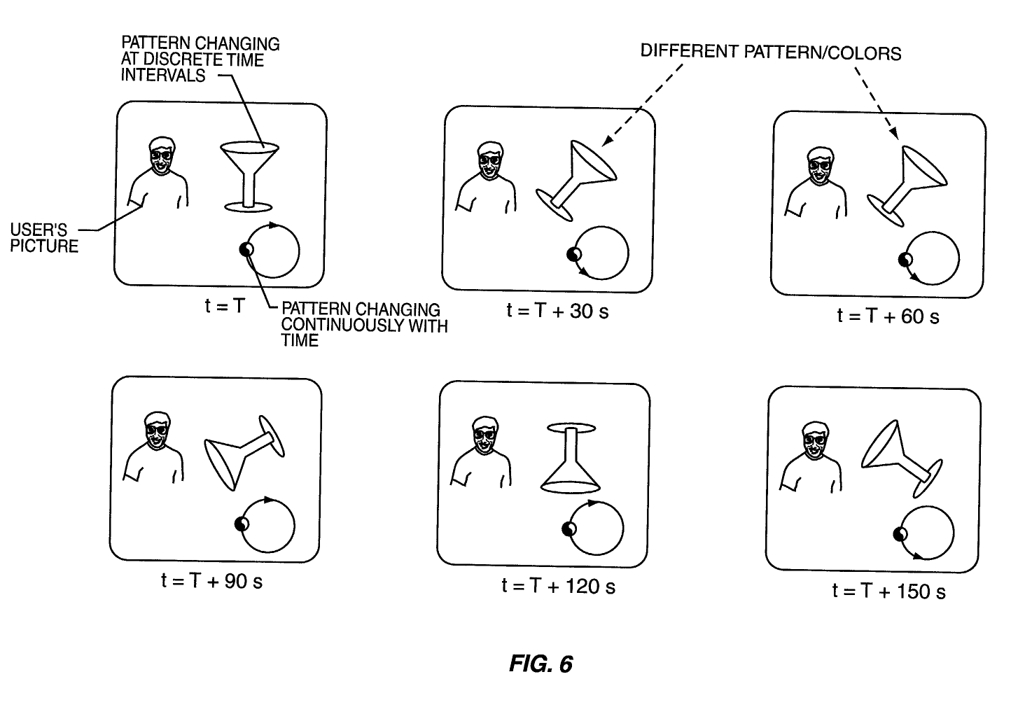

FIG. 6 illustrates one embodiment of a human-verifiable RVT. The depicted images may be displayed on a display screen included within the user interface 54 in the PTD 16. In this exemplary embodiment, the displayed image includes (a) the user's picture, which is typically static; (b) a recognizable pattern that changes at discrete time intervals; and (c) a recognizable pattern changing continuously with time.

The user's picture in (a) above is accessed by the TRS 14 from a server whose location address, as typified by an Internet url, is contained in the PTD certificate sent by the PTD 16 to the TRS 14 in message C in association with signing the composite data object. This image, possibly in compressed form, is forwarded by the TRS 14 to the PTD 16 as a part of the rapid verification object (RVO) in message D.

As an example of (b) and (c), the illustration of FIG. 6 shows a wine glass and ball in association with the user's image. The wine glass takes on a series of rotational angles, wherein the sequence of rotational angles assumed by the wine glass are determined by the sequence/pattern generator 64, based on the seed value provided by the TRS 14 and a time-of-day value. The wine glass image changes at discrete time instants which are sufficiently spaced to allow easy human verification. The exemplary time interval shown in FIG. 6 is 30 seconds. In this case, the defense against replay attack is the presence of the user's picture as a component of the verification image displayed by the PTD 16.

Regarding the image component (c), it may be advantageous to pick the ball as following a circular orbit in an essentially continuous motion where the direction of rotation of the ball is determined by a pseudorandom sequence, and the position of the ball in its circular path is determined by the time-of-day. A continuously varying component in the verification image provides a defense against replay attacks comprising real time monitoring and rebroadcast of the image to multiple fraudulent users.

The human operator may have a rapid verification system 100, such as a hand-held device, having a display with similar images following the same pseudorandom sequence or sequences. In this manner, the human operator can look at the PTD's display and compare the verification image depicted there with the reference image displayed by the rapid verification system 100.

In ensuring that the displayed patterns on the rapid verification system 100 remain in sync with the patterns being generated by PTD 16 having valid RVTs, the rapid verification system 100 may synchronize its time of day to the same time reference used by the security element 20 in the PTD 16. Thus, the rapid verification system 100 may synchronize its time of day to a network time of day, such as the time maintained by the wireless communication network 22, or may also have a GPS-based time reference. Alternatively, the rapid verification system 100 may simply maintain a very accurate time of day, and allow for slight variations between its time of day and the times of day in the PTD 16. Thus, slight discrepancies between the PTD image and the verification image may be tolerated.

As mentioned earlier, an alternative approach has the PTD 16 provide the time-of-day to the rapid verification system 100. This allows the rapid verification system 100 to use the same time-of-day value as was used by the security element 20 in generating pseudorandom data from the seed value. With this approach, the rapid verification system can determine whether the time-of-day value provided by the PTD 16 is recent enough to be deemed legitimate. That is, if the time-of-day value received from the PTD 16 is too old, the rapid verification system 100 can reject the verification sequence or pattern provided to it as being a replay of an earlier verification sequence.

Use of a verification sequence is particularly well suited where verification is performed using automated processing. Thus, the RVT generated by the security element 20 and transmitted from the PTD 16 to the rapid verification system 100 might simply be a verification sequence having at least one pseudorandom element generated in dependence on the seed value provided by a legitimate TRS 14 and a PTD time-of-day. The verification sequence can include additional, non-pseudorandom information, such as protocol-defined headers, etc. As with the human-readable version, the rapid verification system 100 may determine whether a sequence is valid based on the known seed value and a synchronized time of day.

If the rapid verification system's time of day is not synchronized to the same reference used by the security element 20, rapid verification system 100 may compare the received sequence to one of several valid sequences representing a defined time window. In this matter, absolute synchronization of times between PTD 16 and rapid verification system 100 is not necessary; however, by defining the non-discrepancy tolerance to be suitably small (e.g., ±2 seconds), the rapid verification system 100 ensures that an earlier issued seed value has not been redistributed to another PTD 16 for fraudulent reuse.

As noted in detail above, the PTD 16 may include the actual time-of-day value used by the security element 20 in generating the pseudorandom element or elements as a preamble in the verification sequence it transmits to the rapid verification system 100. This technique is useful in that the rapid verification system's time-of-day may not exactly match the time-of-day reference used by the security element 20. The rapid verification system 100 will check the received verification sequence against its own reference sequence for the PTD-declared time-of-day (i.e., for the time-of-day value received from the PTD). If the received verification sequence is valid, this proves that the PTD 16 (security.element 20) had the correct seed value. The rapid verification system 100 will then decide if the PTD-declared time-of-day is within acceptable limits of clock inaccuracy and processing delay. Verification sequences reflecting excessive delays would be rejected as they might result from replay fraud.

In an alternate exemplary approach, the rapid verification object returned by the TRS 14 is a paper ticket or other physical token that may be redeemed by the PTD user. In this approach, the TRS 14 may mark the physical token with authentication indicia that may change with time to prevent token reuse.

Variations of the above techniques build on the core concepts of secure stored-value data object handling disclosed herein, but address additional details. Such details include but are not limited to addressing memory limitations in the security element 20, the desirability of allowing full visibility of the clear text portions of the stored-value data object, devising a copy protection scheme that does not tie the content of the stored-value data object to the receiving device's identity (i.e., PTD identity), and adopting essentially symmetrical protocols for stored-value data object issuance, reception, and transfer between systems. Adoption of symmetrical protocols allows a given system, such as a PTD 16, to conveniently function as a requesting system and issuing system, which facilitates convenient, secure transfer of stored-value objects between PTDs for example.

In an exemplary approach to reducing the amount of secure memory needed for stored-value data object handling in security element 20, stored-value data objects received by the PTD 16 are specially processed by the security element 20 for subsequent storage in non-secure memory outside of the security element 20. Such non-secure memory might comprise part of functional element 40 in the PTD 16. Memory outside the PTD 16 might also be used for storing or archiving stored-value data objects processed by the security element 20, such as memory in a personal computer (PC) with which the PTD 16 at times may be communicatively coupled. Notably, the processing applied to stored-value data objects by the security element 20 allows storing of the entire object, with relevant portions in clear text form for ease of browsing, in non-secure memory.

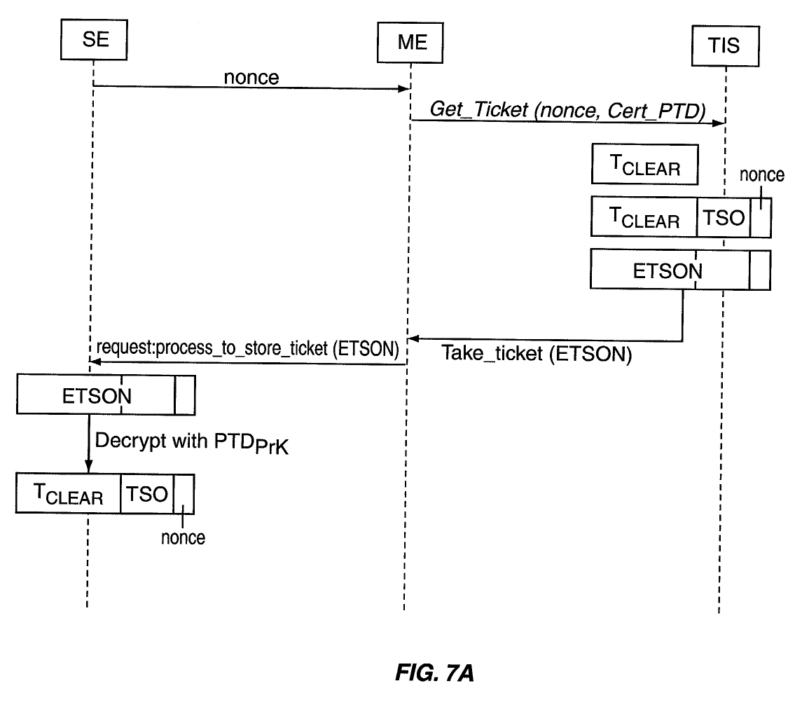

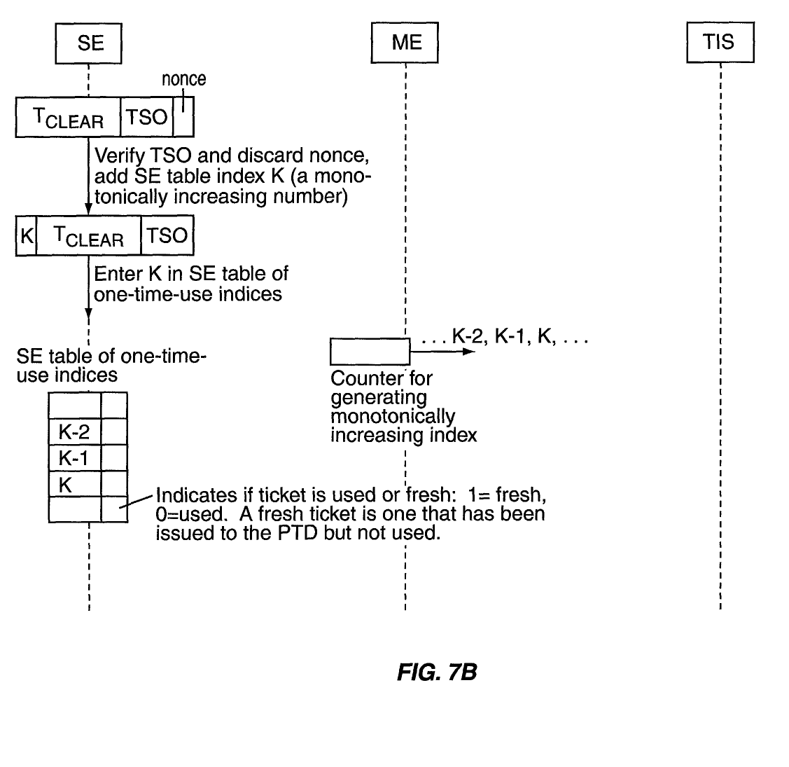

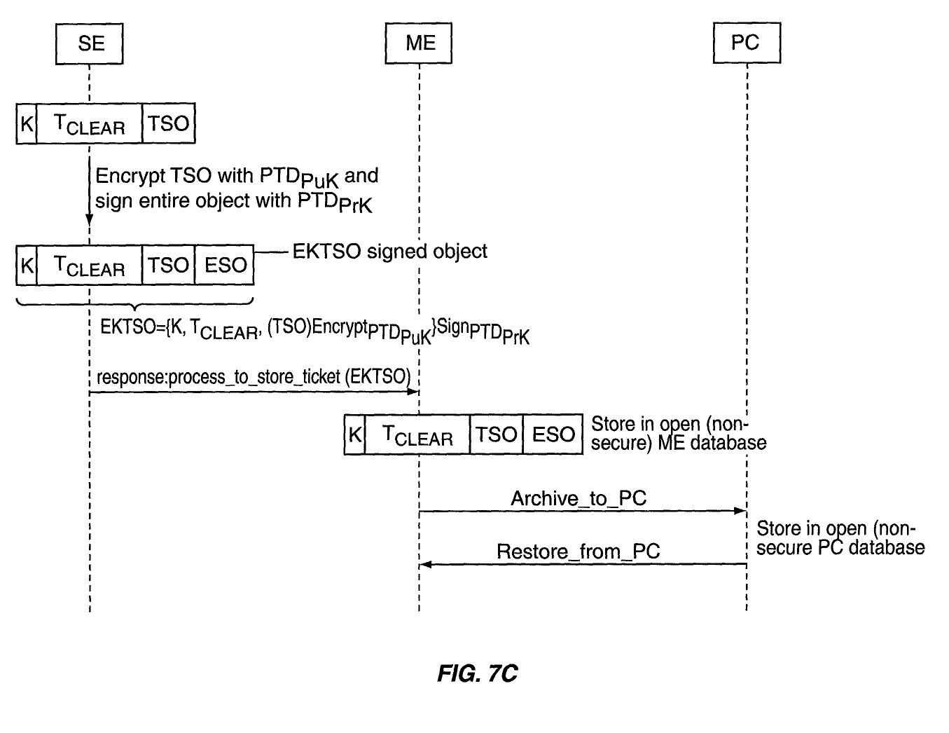

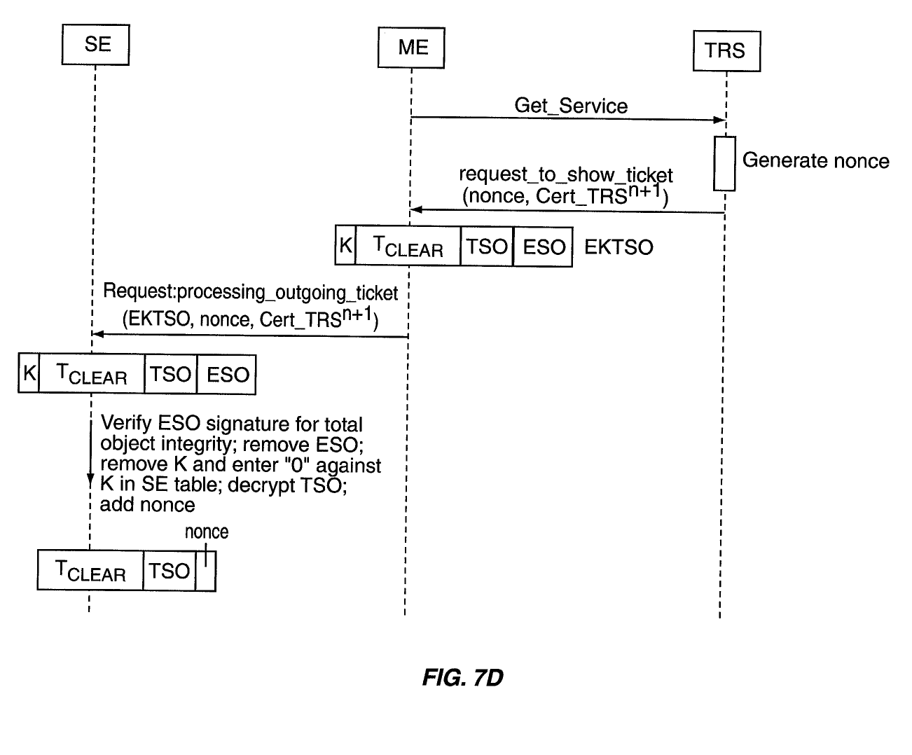

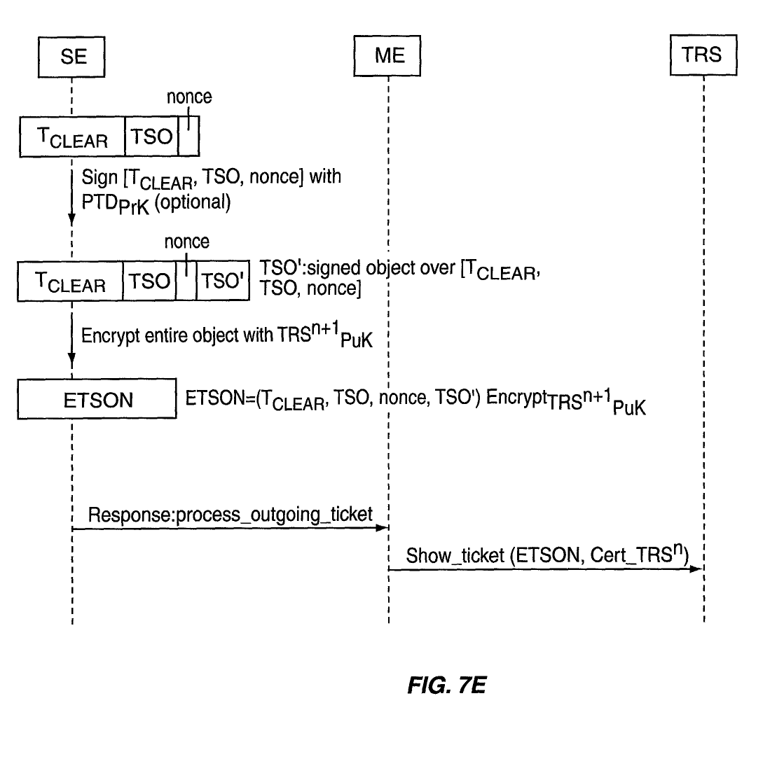

FIGS. 7A-7E illustrate an exemplary operational flow in which the security element 20 operates as a secure processing system or secure element (SE), and the functional element 40 in combination with one or both of the wireless interfaces 42 and 44 acts as a non-secure processing system, collectively referred to as the mobile element or ME. The secure and non-secure parts of PTD 16 cooperate to provide secure and convenient handling of stored-value data objects. More particularly, the SE cooperates with the ME to request, receive, store, and redeem a stored-value data object such as an electronic ticket 18 in a manner that allows storage of the stored-value data object in unsecured memory without compromising processing security or reliability.

Exemplary operations begin in FIG. 7A with the PTD 16 requesting a stored-value data object (e.g., electronic ticket 18) from the TIS 12, and sending a nonce and PTD certificate with that request, or associated with that request. For purposes of discussing this embodiment and related embodiments, the electronic ticket 18 denotes a software data object having some content (not specified here) that is signed by the TIS 12 using its private key. Notably, the content of the ticket is not tied to or dependent upon the recipient's identity, thereby keeping the ticket anonymous and easily transferable without compromising security of use. In other words, security of the issued ticket is not dependent on identification information tied to the requesting party, here the PTD 16.

As before, the PTD 16 might send the ticket request using a wireless network (e.g., cellular GSM or CDMA), using short-range radio (e.g., Bluetooth, 802.11), or send it via some other communication link. In some embodiments, the PTD 16 provides Internet (Web) browsing capability and, as such, the PTD 16 might generate the Get_Ticket request as a function of the user selecting a ticket download link from a Web page associated with the TIS 12. A user certificate, Cert_PTD, is sent ahead of the ticket request, or is otherwise accessible to the TIS 12, and may be part of the ticket purchase and payment process. The TIS 12 might issue a challenge to the requesting PTD 16, with the PTD 16 signing and returning the challenge, which returned information can be retained by the TIS 12 as proof-of-issuance. As mentioned above, a nonce is also sent as part of the Get_Ticket request, this nonce having been generated by the SE 20, and forward to the TIS 12 by the ME (mobile equipment) portion of the PTD 16, also referred to as the functional element 40. Note that in general, the designator ME may be used to broadly refer to the portions of the PTD 16 not including the SE (security element 20), and thus can encompass, among other items, the functional element 40, and the communication interfaces 42 and 44.

Regardless of how the request is generated and transmitted to the TIS 12, the TIS 12 forms an encrypted object referred to as the “ETSON” object for transfer to the requesting PTD 16. The ETSON object derives its name from its formation as an encrypted composite structure comprising the clear ticket information, T_{CLEAR}, a ticket signed object (TSO), and the nonce received from the PTD 16 (Encrypted Ticket, ticket SO, and Nonce).

T_{CLEAR} represents the content of the ticket, and generally relates to information regarding the services or goods for which the ticket may be redeemed. Such content might include, but is not limited to, event date, time and location, service details, face value, refund details, issuing party identification, etc. In the context of this embodiment of the present invention, T_{CLEAR} does not need to contain any data that specifically ties it to the PTD 16. The lack of any such requirements preserves the anonymity of T_{CLEAR}, as discussed above.

TSO represents the ticket signed content, which is uniquely tied to the TIS 12 and which allows subsequent verification of ticket authenticity. In an exemplary embodiment, the TIS 12 forms the TSO by encrypting a hash of T_{CLEAR} content using the TIS's private key TIS_{PrK}. In other words, the TIS 12 signs the ticket using its private key, TIS_{PrK}, to insure the subsequent ability to reliably verify the ticket's authenticity. Thus formed, the ETSON object is returned to the requesting PTD 16 through any of the above communication means, where it is received by the ME of the PTD 16.

The ETSON object is encrypted by the TIS 12 using the public key, PTD_{PuK}, of the requesting PTD 16 as obtained from the PTD certificate, (Cert_PTD), which may be sent in association with the Get_Ticket message. A payment or purchase certificate, possibly issued by a separate payment service, such as a bank, might be used as the PTD certificate. In such instances, the root certificate corresponding to the third-party payment certificate is accessible to the TIS 12.

The ME supports software or other program routines enabling it to conduct certain pre-defined transactions with the SE. In the instance of receiving the stored-value data object in ETSON object form from the TIS 12, the ME sends a request to the SE to process the received stored-value data object for storage in non-secure memory. In this embodiment, the ME sends the SE a “request:process_to_store_ticket” message, passing the stored-value data object (here, ETSON) to the SE as part of that message. It is noteworthy that the said message is the “request” part of a “request/response” message pair between the ME and SE. In general, the ME includes software or other program routines adapted to the input/output functions defined for the SE.

Regardless of the particular message type or format it uses, the ME transfers the ETSON object to the SE for secure processing. Upon receiving the ETSON object from the ME, the SE decrypts it using the SE's private key, PTD_{PrK}. By decrypting the ETSON object, the SE recovers the stored-value data object in its native form, comprising T_{CLEAR} and TSO, and further, recovers the request nonce that was sent as part of the Get_Ticket message. One notable aspect of the request nonce being returned to the requesting party is that such return allows the requesting party to verify that a malicious agent or program in the ME is not fraudulently presenting a copy of an earlier requested ticket. That is, the nonce allows the SE to ensure the “freshness” of the ticket being presented to it for processing.

At this point, the SE has recovered T_{CLEAR} and TSO from the ETSON object. The clear text portion, T_{CLEAR}, of the stored-value data object may be thought of as the “value” portion of the ticket, while the signed object, TSO, represents the authentication portion of the ticket. As an example, the ticket might be formed in accordance with PKCS #7 standards, as explained in the Technical Note published by RSA Laboratories, entitled “PKCS #7: Cryptographic Message Syntax Standard,” Version 1.5, dated Nov. 1, 1993. In accordance with that standard, the value portion of the ticket is referred to as “content” and the authentication portion is called the “EncryptedDigest,” which is a sub-item under “signerInfos” in the standards document.

In any case, the discussion now transitions into FIG. 7B, where the SE discards the nonce after verifying that it matches the nonce previously generated by it in conjunction with the ticket request. The SE then verifies the TSO by decrypting the TSO using the TIS public key, TIS_{PuK}, retained in the TI_ROOT_CERT that is securely held in the SE's memory 52. Such verification might, for example, comprise the SE obtaining a hash value from the decryption of TSO, and then hashing the clear text content T_{CLEAR} using the same hashing algorithm as that employed at the TIS 12 to obtain an independently generated hash value, and then comparing the two hash values. Matching hash values would indicate the authenticity of the TSO.

Once the TSO is verified, an index number K is generated by the SE to uniquely identify the ticket being processed, and is added to the composite ticket object comprising K, T_{CLEAR}, and TSO. The SE writes the index value K into a table of such index values that is securely held within memory 52. A flag or indicator value is also written into the table in association with the index value K by the SE to indicate whether the ticket is “fresh” (i:e., unused). In an exemplary embodiment, a logical “1” indicates a fresh ticket, while a logical “0” equals a used ticket. Note that the value K might be generated as a monotonically increasing index number using a dedicated index generator (counter) in the SE, which could have sufficient counting range to insure that it never runs out of index values, and that no index values are ever repeated. Other generation schemes can be used, with the only qualifier being that no index values are repeated such that each ticket processed by the SE is associated with a unique index value.

Continuing on to FIG. 7C, the SE copy protects the authentication portion of the stored-value data object (TSO) using the SE's public key, PTD_{PuK}. That is, the SE applies another layer of encryption to the TSO (it is already once-encrypted by the TIS 12) using the SE's public key. Then, the SE signs the composite object formed from K, T_{CLEAR}, and the protected TSO to obtain an encrypted signed object, referred to as the “ESO.” In signing the above composite object, the SE uses its private key, PTD_{Prk}. The ESO object serves as a binding value that binds together the specific set of K, protected TSO, and T_{CLEAR}, such that these different pieces cannot be used in combination with information from other stored-value data objects. At this point, the data associated with the stored-value data object includes the index value K, the clear ticket content, T_{CLEAR}, the encrypted TSO, and the binding value, ESO. This composite set of data is collectively referred to as the “EKTSO” object, and may be thought of as a “processed” stored-value data object.

Once it is formed, the SE provides the EKTSO object to the ME for non-secure storage external to the SE using, for example, a “response:process_to_store_ticket” message. This message from the SE is the “response” portion of the “request/response” message pair. Thus, the SE transfers the processed stored-value data object (EKTSO) to the ME responsive to the ME transferring the stored-value data object received from the TIS 12 into the SE. Notably, with the transfer of the EKTSO object to the ME for storage, the SE is relieved of the memory burden associated with retaining the ticket in its secure memory 62. Indeed, the SE only stores the ticket's index value K and the associated freshness indicator (e.g., “1” or “0”), thereby greatly reducing the SE's secure memory requirements.

A further advantage of transferring the processed stored-value data object to the ME's memory 52 is that the clear text value portion (T_{CLEAR}) of it may be easily browsed or inspected by a user of the PTD 16. That is, the user can conveniently browse the clear text content of the EKTSO object without restriction. Such browsing capability significantly enhances the user-friendliness of the PTD 16 in terms of managing the database of stored-value data objects because the user is able to review detailed ticket information.

Notably, this ability to freely browse clear ticket content does not compromise ticket security because of the copy protection through encryption applied by the SE to the authentication portion (TSO) of the original ticket, and because of the use of binding value ESO. That is, the TSO received from the TIS 12 is encrypted by the SE using its PTD_{PuK} before being released to the ME as part of the EKTSO object, this encrypted object being decipherable only by the SE itself, using PTD_{PrK}. Further, the protected TSO is uniquely bound to the K and T_{CLEAR} elements of the EKTSO object by virtue of the binding value ESO. Such operations prevent tampering with or misusing the TSO while it is held in the ME's memory 52, or held in other non-secure memory.

FIG. 7D continues the discussion of stored-value data object (ticket) processing by illustrating an exemplary redemption process, wherein the PTD 16 presents or otherwise redeems the issued ticket to gain access to the associated goods or service. Several considerations bear on the redemption process, including these points: (1) the ticket must be usable only by a legitimate ticket collector; (2) the ticket collector must be able to reliably verify the ticket's authenticity and validity; and (3) if a returned ticket (multi-use applications) is to be sent back to the redeeming PTD 16, that the secure delivery of that return ticket is ensured.

Thus, one objective of the redemption process is to ensure that an eavesdropper cannot subsequently use any copy of ticket it might surreptitiously obtain during transfer of the ticket from the PTD 16 to the TRS 14. Thus, the flow of operations begins with the ME sending a “Get_Service” message to the TRS 14. The Get_Service might be generated by the PTD 16 in response to it accepting a WAP push message containing the Uniform Resource Locator (URL) of the TRS 14, but, of course, other means of getting the TRS's address or connection information to the PTD 16. Regardless, the TRS 14 generates a redemption nonce for the pending transaction responsive to the Get_Service message. It then returns the nonce to the ME, along with the TRS's public certificate, in the form of a “request_to_show_ticket” message, which may be a recognized MIME type.

Note that generation of the redemption nonce by the TRS 14 is similar to the nonce generation by the SE when it originally requested the ticket from the TIS 12. In general, the requesting party, whether PTD 16, TRS 14, or other entity can generate a nonce that is sent by it to the issuing party, and which it can use to verify the information returned to it by the issuing party. In this respect, the present invention in the embodiment being discussed illustrates an exemplary approach to implementing a symmetrical issuance-and-receipt protocol, wherein all devices use essentially the same operations to issue or transfer the ticket from one entity to the next. Such symmetric protocols simply, for example, the transfer of issued tickets from one PTD 16 to the next, or from TRSs 14 to PTDs 16 in multi-use ticket scenarios.

Returning to the redemption details, receipt of the request message from the TRS 14 at the ME triggers an ME application or program that transfers the processed stored-value data object from non-secure memory to the SE for redemption processing. Such transfer is in this exemplary approach accomplished by sending the EKTSO object to the SE as part of a “request:process_outgoing_ticket” message. The ME also transfers the redemption nonce it received from the TRS 14, and the TRS certificate, Cert_TRSⁿ⁺¹ to the SE as part of the processing request. Here, Cert_TRSⁿ⁺¹ denotes the certificate of the current redeeming system to distinguish it from other certificates associated with prior redeeming system that might have been used by the PTD 16 in processing multi-use tickets (e.g., Cert_TRSⁿ, Cert_TRSn⁻¹, etc.).

Once the EKTSO object is transferred to the SE, the SE verifies the binding value (ESO), which was generated using the SE's private key, PTD_{Prk}. Because of the way in which it was generated, the binding value is verifiable only by the SE that generated it. The SE then removes the index value K from the EKTSO object, and enters a “0” for the freshness indicator associated with the index value K to mark the ticket as used.

The SE then, through decryption by its private key PTD_{PrK}, removes the copy protection it earlier applied to the authentication portion (TSO), which operation removes the PTD_{PuK} encryption previously applied to the TSO. At this point, the SE holds a composite object comprising the clear ticket content, T_{CLEAR}, the TSO as generated by the TIS 12 for the original ticket, and the nonce generated by the TRS 14 as part of the redemption request. Thus, the SE has “recovered” the stored-value data object from the processed stored-value data object. The recovered form of the ticket may be thought of as its “native” form plus the nonce.

Turning to FIG. 7E, the SE optionally signs T_{CLEAR}, TSO, and nonce using its private key, PTD_{Prk}, to form the signed object TSO′. The composite structure comprising T_{CLEAR}, TSO, nonce, and TSO′ is then encrypted using the public key of the TRS 14, TRSⁿ⁺¹_{PuK}, which operation forms the stored-value data object as an encrypted composite object referred to as “ETSON.” The ETSON object is then transferred from the SE to the ME through a “response:process_outgoing_ticket” message. Of course, other procedures can be used to effect such transfer. Regardless, the ME receives the ETSON object from the SE and transfers it, along with the certificate, Cert_TRSⁿ, to the TRS 14. Such transfer from the ME to the TRS 14 may be in the form of a “show_ticket” message sent from the PTD 16 to the TRS 14. In any case, the TRS 14 receives the ticket information as part of the transmitted message, and verifies that information using, for example, one or more of the redemption processing steps discussed for the TRS earlier herein.

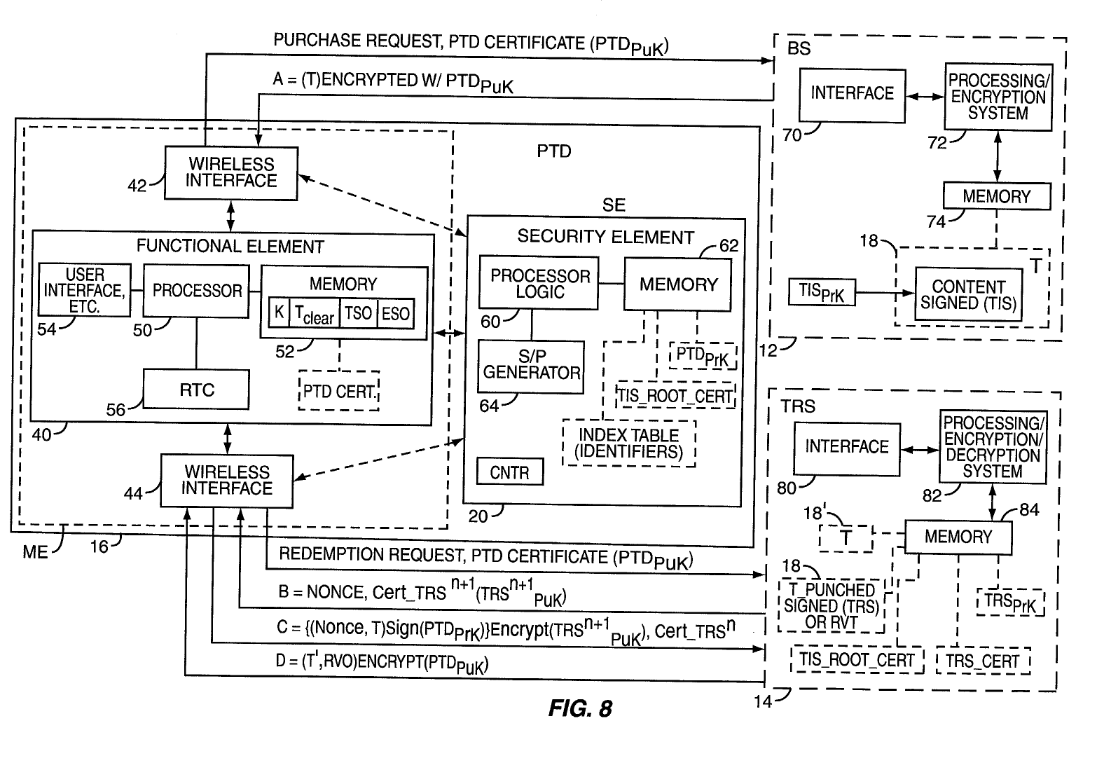

FIG. 8 discloses a variation on the apparatus depicted in FIG. 3, with the modifications representing exemplary changes to support the functionality described in the above discussion of FIGS. 7A-7E. One notes that the SE (security element 20) here incorporates additional functions, including the index counter and index table discussed above. Such additional functions may be gained by literally incorporating hardware-based counters and index registers, gained through added software functions, or through some combination thereof.

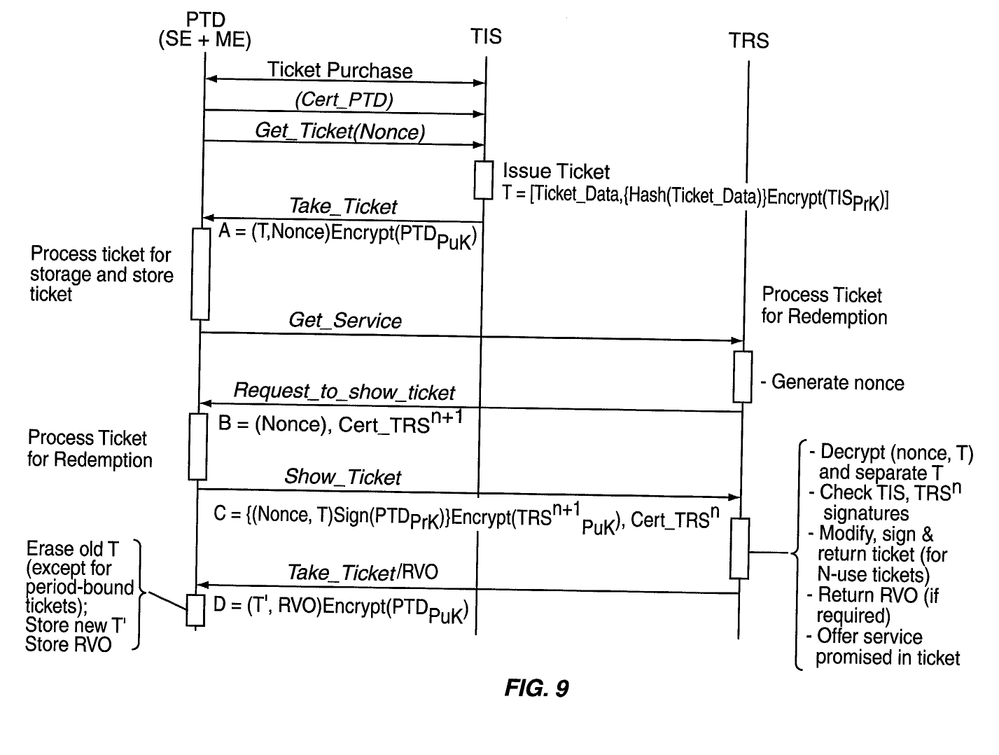

Regardless of the hardware and/or software changes made to the SE, the exemplary messages flowing between the TIS 12, TRS 14, and PTD 16 in support of the above functionality are denoted as messages “A,” “B,” “C,” and “D” in FIG. 9. These messages appear in the context of an overall TIS/PTD/TRS transactional flow. Thus, FIG. 9 offers an integrated message flow diagram that essentially follows the detailed discussion corresponding to FIGS. 7A-7E.

Processing begins with initiation of a ticket-issuance transaction between the PTD 16 and the TIS 12, with the PTD 16 providing its certificate, Cert_PTD, and the issuance nonce for use by the TIS 12. Such actions result in the TIS 12 sending message A, which includes the ticket information described earlier. At some later point, the PTD 16 redeems the ticket, by sending the Get_Service message to the TRS 14. That message from the PTD 16 causes the TRS 14 to generate a request for the PTD to show the ticket being redeemed, which request is denoted as message B in the diagram.

In turn, receipt of message B at the PTD 16 causes it to respond by “showing” the ticket to the TRS 14. Such a showing is made based on the PTD 16 sending message C to the TRS 14, which message includes the information described earlier and indicated in the illustration. Note that in some applications, redemption of the ticket does not require or necessitate return ticket information, but might where the ticket is a multi-use ticket, or where RVOs are needed by the user. In such instances, the TRS 14 returns message D, which is similar to the Take_Ticket return message discussed above in, for example, the context of FIG. 4.

Given the broad scope of the present invention with regard to issuing, managing and redeeming electronic tickets or other stored-value data objects within the realm of e-commerce or in the context of other types of secure transactions, it should be understood that the exemplary details above are not limiting. Indeed, the present invention is limited only by the scope of the following claims, and the reasonable equivalents thereof.

What is claimed is:

1. A method in a communication device of securely managing stored-value data objects, the method comprising:
receiving a stored-value data object comprising a value portion and an authentication portion at the communication device;
performing, in a secure element comprising a portion of the communication device, the steps of:
verifying the stored-value data object;
associating the stored-value data object with an index value stored in the security element;
protecting the authentication portion of the stored-value data object; and
generating a binding value that binds the value portion, the authentication portion, and the index value; and
storing the binding value, the index value, the value portion as clear text, and the protected authentication portion, together as a processed stored-value data object in non-secure memory accessible to the communication device.

2. The method of claim 1, further comprising performing, in the secure element, the step of storing a flag corresponding to the index value in the secure element that indicates whether or not the stored-value object has been used.

3. The method of claim 2, wherein storing a flag corresponding to the index value in the secure element comprises setting the flag to indicate an unused state in conjunction with storing the processed stored-value object in non-secure memory to indicate that the processed stored-value object has not been used.

4. The method of claim 3, further comprising setting the flag to indicate a used state in conjunction with receiving the processed stored-value object at the security element for redemption processing.

5. The method of claim 1, wherein protecting the authentication portion of the stored-value data object comprises copy protecting the authentication portion of the stored-value data object through public-key encryption using a public key for which the corresponding private key is securely held by the communication device.

6. The method Qf claim 1, wherein generating a binding value that binds the value portion, the authentication portion, and the index value comprises encrypting the index value, the value portion, and the protected authentication portion with a private key securely held by the secure element to form the binding value.

7. The method of claim 1, wherein verifying the stored-value data object comprises verifying the authentication portion of the stored-value data object to ensure that the stored-value data object was issued by a legitimate issuing system.

8. The method of claim 7, wherein verifying the authentication portion of the stored-value data object comprises decrypting the authentication portion using a first key associated with the issuing system, and wherein the first key is securely retained in the security element.

9. The method of claim 8, wherein the issuing system encrypts the stored-value data object using a second key that is associated with the communication device before sending the stored-value data object to the communication device.

10. The method of claim 9, wherein verifying the authentication portion of the stored-value data object further comprises decrypting the stored-value data object using a third key stored in the secure element to obtain the authentication portion.

11. The method of claim 1, wherein the stored-value data object is received at the communication device responsive to requesting the stored-value data object, and wherein requesting the stored-value data object comprises:
generating a request nonce in the secure element; and
sending a request message from the communication device to the issuing system, wherein the request message includes the request nonce.

12. The method of claim 11, wherein the issuing system includes the request nonce in the stored-value object returned to the communication device, and wherein verifying the stored-value data object in the security element comprises verifying the request nonce.

13. The method of claim 12, wherein verifying the stored-value data object further comprises verifying the authentication portion of the stored-value data object.

14. The method of claim 13, wherein verifying the authentication portion of the stored-value data object comprises decrypting the authentication portion using a first encryption key associated with the issuing system that is stored in the security element.

15. The method of claim 1, further comprising sending a stored-value data object from the communication system to a redeeming system for redemption.

16. The method of claim 15, wherein sending a stored-value data object from the communication system to a redeeming system for redemption comprises:
retrieving a processed stored-value data object corresponding to the stored-value object being redeemed from the non-secure memory accessible to the communication device;
transferring the processed stored-value data object to the security element of the communication device, and in the security element performing the steps of:
verifying the index value to insure that the index value matches a stored index value in secure memory;
verifying the binding between the index value, the protected authentication portion, and the value portion, of the processed stored-value object;
removing the protection previously applied by the security element to the authentication portion to recover the stored-valued object comprising the value portion and the authentication portion; and
encrypting the stored-value data object using a redemption key received at the communication device from the redeeming system; and
sending the encrypted stored-value data object from the communication device to the redeeming system.

17. The method of claim 16, further comprising:
receiving a redemption nonce from the redeeming system; and
adding the redemption nonce to the stored-value object in the secure memory element before encrypting it with the redemption key.

18. The method of claim 16, wherein removing the protection previously applied by the security element to the authentication portion to recover the stored-valued object comprising the value. portion and the authentication portion comprises removing encryption applied by the secure element in the step of protecting the authentication portion.

19. A communication device for securely managing stored-value data objects, each comprising a value portion and an authentication portion, the communication device comprising:
a non-secure element to communicate with stored-value data object issuing and redeeming systems; and
a secure element communicatively coupled to the non-secure element, and programmed to:
receive a stored-value data object from the non-secure element;
verify the stored-value data object;
associate the stored-value data object with an index value stored in the secure element;
protect the authentication portion of the stored-value data object;
generate a binding value that binds the value portion, the authentication portion, and the index value; and
transfer the binding and index values, along with the value and authentication portions of the stored-value data object, to the non-secure element as a processed stored-value data object for storage.

20. The communication device of claim 19, wherein the secure element protects the authentication portion of the stored-value data object by encrypting the authentication portion using a public key for which the corresponding private key is securely held by the communication device.

21. The communication device of claim 19, wherein the secure element generates a binding value that binds the value portion, the authentication portion, and the index value by encrypting the index value, the value portion, and the protected authentication portion with a private key securely held by the secure element to form the binding value.

22. The communication device of claim 19, wherein the secure element stores a flag in association with the index value that indicates whether or not the stored-value object associated with the index value is used or unused.

23. The communication device of claim 19, wherein the secure element sets the flag to indicate an unused state for the stored-value object before transfer to the non-secure element for storage as the processed stored-value data object.

24. The communication device of claim 19, wherein the secure element sets the flag to indicate a used state for the stored-value object upon transfer of the processed stored-value data object from the non-secure element into the secure element for redemption processing.

25. The communication device of claim 19, wherein the secure element generates a request nonce for each issuance request sent from the communication device to an issuing system.

26. The communication device of claim 25, wherein the secure element verifies the stored-value data object in part by verifying that the stored-value data object includes a request nonce previously generated by the secure element.

27. The communication device of claim 26, wherein the secure element further verifies the stored value data object by decrypting the authentication portion of the stored-value data object using a first key that is associated with the issuing system and securely retained in the secure element.

28. The communication device of claim 19, wherein the non-secure element transfers the processed stored-value object from non-secure memory back to the secure element for redemption processing, and wherein the secure element:
verifies the binding between the index value and the authentication and value portions based on the binding value;
confirms that the index value matches a stored index value in the secure element;
removes the protection applied by the secure element to the authentication portion to recover the stored-value data object as comprising the value and authentication portions;
encrypts the stored-value data object using a redemption key associated with a redeeming system with which the stored-value data object is being redeemed; and
transfers the encrypted stored-value data object to the non-secure element for transfer to the redeeming system.

29. The communication device of claim 28, wherein the secure element removes the protection applied by the secure element to the authentication portion to recover the stored-value data object by decrypting the protected secure element to remove an encryption applied to the authentication portion by the secure element as part of the step of protecting the authentication portion.

30. The communication device of claim 28, wherein the secure element verifies that a flag stored in the secure element in association with the index value indicates that the processed stored-value object has not be previously processed for redemption.

31. The communication device of claim 30, wherein the secure element sets the flag to indicate a used state for the processed stored-value data object to prevent subsequent redemption processing should the same processed stored-value data object be presented to the secure element for redemption processing.

32. The communication device of claim 28, wherein the secure element adds a signed object to the stored-value object before encrypting the stored-value object for authentication by the redeeming system.

33. The communication device of claim 28, wherein the secure element adds a redemption nonce received by the communication device from the redeeming system to the stored-value data object before encrypting the stored-value data object.
